(19) United States
(12) Patent Application Publication
(10) Pub. No.: US 2006/0242161 A1
(43) Pub. Date: Oct. 26, 2006

(54) Dvd-linked internet bookmarking

(76) Inventors: Warner R. T. Ten Kate, Eindhoven (NL); Declan P. Kelly, Shanghai (CN); Yang Peng, Shanghai (CN); Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/565,819

(22) PCT Filed: Jul. 20, 2004
(86) PCT No.: PCT/IB04/51261

§ 371 Date: Jan. 24, 2006

(30) Foreign Application Priority Data
Jul. 28, 2003 (EP) 03102311.2

(51) Int. Cl. G06F 7/00; G06F 15/16; G06F 17/00

(52) U.S. Cl. 707/100; 715/513; 709/203

(57) ABSTRACT

A system 100 includes a rendering apparatus 120, a server 110 and a network 130. Content items on the server are identified by respective server content locators, such as a URL. The rendering apparatus also has access to local content. Titles of the local content are associated with respective local content identifiers, such as title IDs. The system can generate and store a plurality of bookmarks, that each include a server content locator and a local content identifier. The rendering apparatus can render items of the local content and server content items that relate to the local content items. The rendering apparatus renders a server content item indicated by the server content locator of a bookmark conditional on having access to a local content title associated with the local content identifier of the bookmark.

### FIELD OF THE INVENTION

The invention relates to a system including a rendering apparatus, a server and a network for communication between the rendering apparatus and the server. The rendering apparatus is able to render local content and content from the server. The server content can be bookmarked.

### BACKGROUND OF THE INVENTION

New forms of consumer electronics products are continually being developed. Many efforts have been focused on the convergence of computer technology and home entertainment systems. Important areas are interactive applications and enhanced functionality, by merging locally available high quality content and content retrieved from the Internet. eDVD is such a technology in which a Digital Versatile Disc or Digital Video Disc (DVD) disc is linked to web content of a web site, wherein the web content is directly related the content on the DVD disc. The content on the DVD may include video and audio content. eDVD provides fast access to high-quality video and audio data offered by DVD along with advantages offered by internet technology (e.g., interactivity, dynamic updates, etc.). For example, eDVD enables a local DVD to be enhanced with HTML web pages. WO 00/63915 describes such a eDVD system that integrates a WWW web browser into a DVD rendering apparatus. Uniform Resource Locator (URL) information corresponding to information on sites accessible by the browser is stored in fields within the DVD data. When the user actuates a DVD element that has such a corresponding URL link, the web browser displays the information pointed to from that site. When the user actuates an HTML menu or other browser-implemented feature, the DVD system accesses a portion of the DVD data specified in the menu. This arrangement provides for two-way communication, i.e. HTML in the browser is able to control DVD content and vice versa. Having a link between the web information and the DVD content makes it possible to present web content synchronous with the rendering of DVD information. The browser in the DVD player may be based on a conventional web browser. The web content is stored in a server accessible through the Internet.

### SUMMARY OF THE INVENTION

It is an object of the invention to enhance the integration between rendering of content locally accessible by the rendering apparatus and of the content accessible through the server.

To meet the object of the invention, a system includes a rendering apparatus, a server and a network for communication between the rendering apparatus and the server;

the server having access to content, hereinafter referred to as “server content”; separately accessible items of the server content being identified by respective server content locators, such as a URL;

the rendering apparatus having access to further content, hereinafter referred to as “local content”; titles of the local content being associated with respective local content identifiers; the rendering apparatus being operative to render items of the local content and to render server content items that relates to the local content items;

the system being operative to generate and to store a plurality of bookmarks identifying respective server content items; each bookmark including a server content locator and a title identifier; and

the rendering apparatus being operative to render a server content item indicated by the server content locator of a bookmark conditional on having access to a local content title associated with the local content identifier of the bookmark.

According to the invention, bookmarks are extended with a reference to the local content title to which the server located content relates. This enables a much smoother integration of both aspects. The local content is preferably stored on a removable storage medium, such as a CD, DVD, Blu-ray disc, solid-state storage, etc, but may also be stored on a fixed storage medium, such as a hard disk in a local multi-media server or in the rendering apparatus, e.g. as defined by UPnP (Uniform Plug and Play). The local content identifier may take any suitable form and may depend on the storage type. For example, for a DVD the local content identifier may be based on any of the following specific content or any combination of the following specific content relating to the DVD disc and appearing on, or associated with, the DVD disc: TitleID, PublisherID, PublisherGroupId, PublisherUniverseId, DiscID, DiscFamilyID, WebUniverseld, and a signature (such as a hash of data) of the DVD disc. The local content identifier may uniquely identify the local content title (e.g. using the TitleID) or even the unique instance of the title (e.g. using a combination of the TitleID and DiscID). The association between the local content identifier and the title need not be unique. For example, the local content identifier may be a DiscFamilyID that uniquely identifies a set of titles (e.g. all Star Wars movies) or PublisherID. Having local access to one Star Wars movie may, in certain applications, entitle the user access to additional web based content for all movies.

It should be noted that bookmarking of server content is known from web browsers. It is also known to bookmark DVD content, for example in a way as described in US 20020078144. The known systems do not describe using bookmarks that link content in the local environment, typically CE devices, to content in a server environment (typically the computer environment in the Internet), where access to the server content is conditional on the local content. In addition to improving user friendliness, the bookmarked linking enables better protection of the content. For example, access to the server-based content can now in an easy way be limited to users that have access to the local content (e.g. those that have legally obtained the DVD with the content) to which the web-based content relates. Only if such a DVD is placed in or otherwise accessible by the rendering apparatus the additional web-based content can be rendered. It can thus be avoided that non-paying users can benefit from additional web-based games or information.

According to the measure of the dependent claim 2, the additional information in the bookmark on the title to which the server content relates is used to present bookmark information to a user. For example, only bookmarks that point to server content that is available for rendering, e.g. in view of the corresponding local content being accessible at that moment, are presented or highlighted. Bookmarks that point to server content that at that moment can not be rendered are not selectable (e.g. not shown or shown in a distinctive manner (“grayed”)). To the user of the system this provides the benefit of simplifying the navigation through the bookmarks. For example, only those relevant (related) to the currently playing/active disc are presented on the user interface, enabling simple (e.g. arrow-based, jumping-highlight) interaction.

According to the measure of the dependent claim 4, the bookmarks presented by the user interface are organized (e.g. sorted) according to the respective title identifiers of the bookmarks.

According to the measure of the dependent claim 5, preferably the rendering apparatus renders a server content item indicated by the server content locator of a bookmark synchronous to rendering the local content title identified by the title identifier of the bookmark. Selection of a bookmark can trigger rendering of both the local title and the corresponding server content.

According to the measure of the dependent claim 6, separately accessible items of the local content are identified by respective local content locators. The bookmark includes a local content locator enabling starting the rendering of the local content title at a location indicated by the local content locator. This enables more accurate synchronization of the rendering. The local content locator may take any suitable form, such as a URL (Uniform Resource Locator), URN (Uniform Resource Name), URI (Uniform Resource Identifier), or any other suitable locator, such as a time indicator within the title, and combination thereof.

According to the measure of the dependent claim 7, the bookmark includes a user ID identifying a user of the rendering apparatus, and/or a family ID identifying a family of users of the rendering apparatus. This enables personalization of the rendering. The family ID may, for example, be used for any bookmark relevant for the entire family. A bookmark that points to a part of a web site with unrestricted access may by default be assigned to the family ID. A bookmark that points to a part with restricted access (e.g. with adult material) is preferably by default assigned to the user ID of the current user. In this way also a separation can be achieved between bookmarks of general interest and of interest to only one user. This keeps the bookmarks list shorter and simplifies navigation through the bookmarks.

According to the measure of the dependent claim 8, the stored bookmarks are presented organized according to the user ID and/or family ID of the bookmarks. For example, the bookmarks may be sorted per user or only presented if the user ID matches the User ID given by a user to the rendering apparatus for the current rendering session. In this way bookmarks to different parts of a web site (or even different web sites) targeted at and selected by different types of users (e.g. male/female; young/old) can be kept separate. This enables a user to quickly retrieve the bookmarks of interest. Unlike is the case for PC web browsers, the user does not need to perform a full log-in procedure to have access to user-specific bookmarks. The entire bookmark list can simply be filtered with the user ID of the current user.

According to the measure of the dependent claim 9, the bookmark includes a parental level indicator. The rendering apparatus is operative to present a bookmark and/or to render a remote item indicated by a bookmark only if the parental level indicator of the bookmark matches a parental level setting of the rendering apparatus. In this way, parental setting that may control the local rendering are applied in the same way to rendering of the remote content.

According to the measure of the dependent claim 10, the system creates a bookmark in response to an instruction of the user, e.g. a one-click operation on a remote control. Preferably, the bookmark couples the web content currently being rendered and the local content currently being accessible (e.g. in the DVD drive or being rendered from the DVD drive or an in-home multi media server).

According to the measure of the dependent claim 11, the system generates at least some of the bookmarks automatically. This enables a further convergence of the CE and PC environments. In particular, according to the measure of the dependent claim 12, the system automatically generates a bookmark for a server content item in response to an instruction to terminate rendering of a server content item to enable resumption of rendering of the server content item. Upon resumption of the rendering of the title, automatically the rendering of the server content can be restarted.

According to the measure of the dependent claim 13, the system generates a bookmark for a server content item in response to a user selecting a server content item for rendering. In this way, automatically a history list of bookmarks is created, enabling simple stepping back to already rendered server and local content.

According to the measure of the dependent claim 14, the rendering apparatus is operative to verify an authenticity of an accessible local content title and to render a server content item indicated by the server content locator of a bookmark only upon a positive outcome of the verification. In this way, access to the server content can be limited to user that have legally obtained the local content. Most current storage media for local usage enable verification of the authenticity of the medium.

The meet an object of the invention, a method of generating a bookmark to content in a server accessible through a network includes:

retrieving a local content identifier associated with a title of content accessible for rendering by a rendering apparatus local to the content;

retrieving a server content locator, such as a URL, identifying a separately accessible item of the server content that is related to the local content title; and

generating and storing a bookmark that includes the server content locator and the local content identifier.

To meet an object of the invention, a method of accessing content in a server accessible through a network includes:

retrieving a bookmark that includes:
a local content identifier associated with a title of content accessible for rendering by a rendering apparatus local to the content; and
a server content locator, such as a URL, identifying a separately accessible item of the server content that is related to the local content title; and
rendering a server content item indicated by the server content locator of the bookmark conditional on having access to the local content title associated with the local content identifier of the bookmark.

These and other aspects of the invention are apparent from and will be elucidated with reference to the embodiments described hereinafter.

### BRIEF DESCRIPTION OF THE DRAWINGS

In the drawings:

FIG. 1 shows a block diagram of the system according to the invention;

FIG. 2 shows a block diagram of a more extended system in which the invention may be used;

FIG. 3 shows a block diagram of the rendering apparatus according to the invention; and

FIG. 4 shows an example of a structure of a bookmark file.

### DETAILED DESCRIPTION OF THE PREFERRED EMBODIMENT

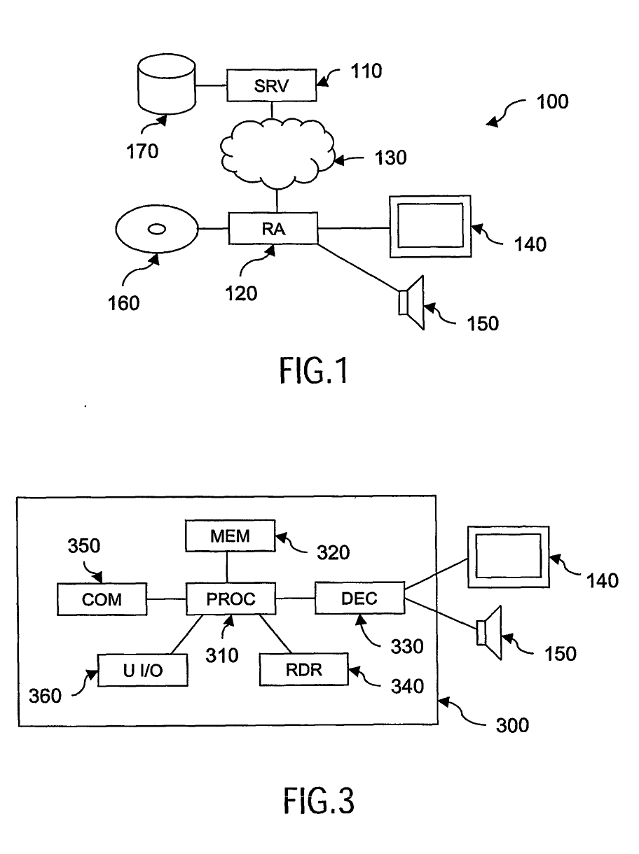

FIG. 1 shows a block diagram of the system 100 according to the invention. The system includes a server 110 and a rendering apparatus 120. The server and rendering apparatus can communicate via a network 130. The network may be a wide area network, such as Internet, but can also be a local area network, such as an in-home network, and combinations thereof. In a particular embodiment, the system may be an eDVD system (also referred to as WebDVD system), where the server is an Internet server providing access to one or more web sites and the rendering apparatus includes a DVD player.

The rendering apparatus has access to local content and can render this content. Typically, the content is digital audio/video content, including digital images. In the example of FIG. 1 the local content is stored in a removable storage medium 160, such as optical storage (e.g. CD, DVD, Blu-ray) or solid state memory (e.g. flash memory). A berth for the medium, such as a DVD drive, may be included in the rendering apparatus. The local content includes one or more content titles (i.e. separately identifiable pieces of content, such as a DVD movie, audio CD, etc.). Each title is associated with a local content identifier. For example, for a DVD the local content identifier may be based on any of the following specific content or any combination of the following specific content relating to the DVD disc and appearing on, or associated with, the DVD disc: TitleID, PublisherID, PublisherGroupId, DiscID, and DiscFamilyID. These identifiers are all defined in DVD specifications. In this description only a summary will be given:
The TitleID identifies the subject content of the DVD disc and does not distinguish other DVD discs having the same subject content.
The PublisherID identifies the publisher of the DVD disc.
The PublisherGroupId identifies a group of DVD publishers that have a direct or indirect relationship to the DVD disc. For example, the group may include the publisher of the DVD disc, and other members of the group may have a relationship to the publisher of the DVD disc.
The DiscID identifies the DVD disc itself and distinguishes other DVD discs having the same TitleID. If a DiscID is not created on the DVD disc during manufacture of the DVD disc, then a DiscID could be subsequently created on the DVD disc if the DVD disc is a rewritable disc.
The DiscFamilyID identifies a family of related DVD discs (i.e., a “Disc Family”) which are related in any manner such as by subject, author, publisher, year of publication, country of publication, etc. For example, a DiscFamilyID could identify all Harry Potter movies.

Other, similar identifiers can extend this list. If the local content itself does not come with a suitable identifier, an identifier may be created, for example, in the form of a signature (such as a hash of data) of distinctive parts of the content (e.g. header information of digitally encoded content). A hashing function of data contained within the DVD disc may be generated from any “statistically unique” data appearing on the DVD disc. The result of the hashing function (or a textual representation of it) can be used as the local content identifier. Possible candidates for a statistically unique data include: data pointers located within tables such as the unique number in the Volume Set Identifier field in the Primary Volume Descriptor table; fields in files which define content and menus such as in ifo files; cell elapse time; start or end addresses of cells; start address of a video object unit (VOBU); etc.

In addition to rendering the local content, the rendering apparatus can also receive and render additional content from the server 110 that relates to the local content. In particular, the server provides enhanced functionality for the local title (e.g. through a web site on the Internet). To this end, the server 110 has access to “server content”, that may be stored in a storage 170. Such storage may be formed by hard discs (e.g. in the form of a RAID device). Items of the local content that area separately accessible by the rendering apparatus are identified by respective server content locators. Any suitable locator may be used. For example, for content on a web server typically a URL (Uniform Resource Locator) may be used. Instead of using an actual locator also an associated descriptor, such as a name, may be used. Preferably, such a descriptor is a Uniform Resource Name (URN). A naming service, as are well-known, can be used to resolve a URN to a URL. The advantage of using a descriptor is that, in general, in this way the content may change location and that multiple copies of the same content can be stored on the network, where the resolution service directs the client to the closest location. In addition, the descriptor can be shorted and more easy to read by a user.

The server may contain many additional information parts, of which some have a clear correspondence with content parts of the title. For example, the server may store in its storage 170 more subtitles or languages than the original title on the storage medium 160. For example, a DVD may have been supplied in different versions for different regional areas. As the different versions are developed more languages and sub-titles may be developed as well. Whereas a DVD typically includes 3 or 4 languages and sub-titles in up to 8 languages, the additional information can be added to the web site on the server. For example, this would enable a Dutch viewer in the US to view the DVD with the US region code (and not including Dutch language and Dutch sub-titles) in Dutch. Preferably, the server then contains information on synchronizing (“linking”) the information on the web site to corresponding content parts of the title. In theory, such linking information can also be embedded in the DVD, but it is preferred to let the server couple the web information to the content in order to be more flexible. As a further example, after the DVD has been completed (and distributed) more functionality may be added, for example an interview with the director, script writers, or actors may be stored on the web site, where parts of the interview link to content parts being discussed. In this way, the viewer watching the interview (retrieved from the web site) can also view the content parts being discussed. Similarly, games and quizzes may be developed and made available through the web site that may or may not link web-based content to the title content. Further examples of enhanced functionality are:
Enhanced menu structures (compared to the original menus on the DVD)
E-commerce, buying items related to the movie (e.g., recent releases of a next version of the movie's series, such as the Matrix Reloaded on a DVD of Matrix)
Promotion of similar/related movie titles
Provide up-to-date profiles of actors, directors, etc.

As described above, the rendering apparatus is able to render both local content and server content and, if so desired, synchronize the rendering. The rendering apparatus may include the actual rendering devices, such as a television display 150 or amplifiers/loudspeaker 150, but may equally well be connected to such devices via a suitable link (e.g. an analogue audio and/or video link, a digital audio link such as SPDIF and/or a digital video link such as DVI) or network (e.g. IEEE 1394 or WiFi).

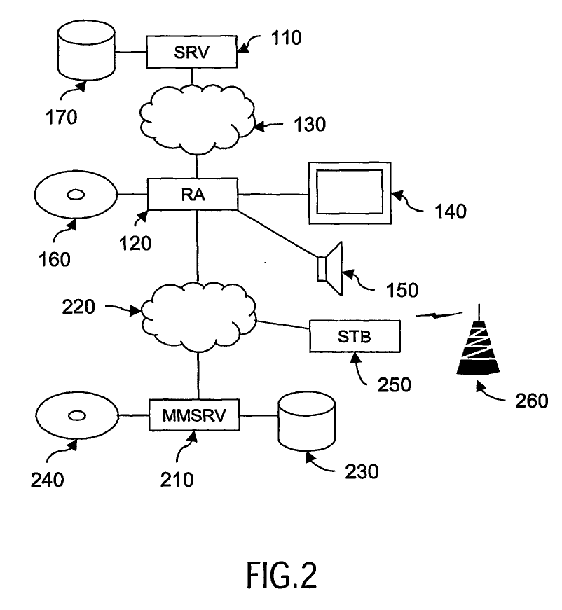

FIG. 2 gives a further embodiment of the system according to the invention. Items indicated using the same numbers as used in FIG. 1 have the functionality as described above. In the embodiment of FIG. 2, the local content is instead or additionally provided to the rendering apparatus via a further communication system 220. This further communication system provides the rendering apparatus high-speed access to the local content. In particular, the further communication system is a local area communication system, such as a computer local area network (e.g. Ethernet, WiFi) or a CE-type of local area network (e.g. IEEE 1394). Using such a system, the local content need not to be stored in a storage 160 that is included in or directly attached to the rendering apparatus. In fact, the local content may be stored in a local server, such as a Multi-Media server 210 known from the Uniform Plug and Play (UPnP) architecture. A Media Server in a UPnP compliant network can contain various types of content that other devices in the network would like to access (e.g. music, videos, still images, etc). The user can select an object stored on the Media Server and cause it to be “played” on an appropriate rendering device (e.g. an audio player for music objects, a TV for video content, an Electronic Picture Frame for still-images, etc). The UPnP AV Architecture allows devices to support different types of formats for the entertainment content (such as MPEG2, MPEG4, DIVX, JPEG, JPEG2000, MP3, ATRAC, AC3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.). Example instances of a Media Server include traditional devices such as VCRs, CD Players, DVD Players, audio-tape players, still-image cameras, camcorders, radios, TV Tuners, and set-top boxes. Additional examples of a Media Server also include new digital devices such as MP3 servers, Personal Video Recorders (PVRs), and Home Media Servers such as the PC. The local content may be supplied to the local server 210 in any suitable way, e.g. via a removable storage medium 240, read directly by the server or through another device in the system, or via a communication system, such as a broadcasting system 260 (e.g. via a cable network, terrestrial broadcasting, or satellite broadcasting). The local server may also download titles from the Internet. For a broadcasting system, a receiver, such as a set top box 250, may be used for receiving the broadcast content, for example, such as known from the DVB-MHP specifications. The local server 210 may store any suitable title identifiers in correspondence with the title content. Preferably, the local server first verifies that the content is authentic before it stores the content and title. It will be understood that the described role of the local server may be integrated with the role of the rendering apparatus according to the invention.

FIG. 3 shows a block diagram of an embodiment of the rendering apparatus 300. Typically, the rendering apparatus includes a processor 310 for controlling other hardware and software function in the apparatus and providing additional software functionality. In particular, the processor may execute browser functionality for browsing through servers in the Internet and through accessible pages on those servers. The processor 310 may be implemented using any suitable processor, such as an embedded microprocessor or microcontroller. Some of the functionality may also be provided using a Digital Signal processor (DSP). The local content is typically stored in an encoded form, for example using MP3, MPEG2, MPEG4, JPEG or DIVX encoding. The local content may be received via a media reader 340, such as DVD drive. The encoded content blocks (usually streams of such blocks) are fed to a decoder 330, which converts them into signals appropriate for the video and audio rendering or storage devices. The rendering apparatus 300 also includes a communication interface 350 for, preferably, bi-directional communication to the server 110. Any suitable communications hardware/software may be used for this, including conventional modems for standard telecommunication lines or broadband modems. The bi-directional communication channel facilitates downloading of the additional server content, such as interactive features or additional interactive audio/video content. It also enables applications that interact through a network, such as interactive video, e-commerce and so on. Preferably, Internet protocols are used, for example those defined in the European MHP (Multi-media Home Platform) “Internet Access Profile” or for the US DASE platform. The relevant audio/video data retrieved from the server will be converted by a converter (such as an audio D/A converter and a graphics processor) to a suitable form for presentation to a user. This may include decoding by the decoder 330. The additional content may be overlaid with the local content (e.g. as sub-titles, or as a Picture-in-Picture), or mixed with the local content. Output of the decoder can be supplied to a rendering device, such as a display 140 or loudspeaker/amplifier 150 or storage device for subsequent rendering. For certain applications, the rendering apparatus may provide encoded output streams, bypassing the decoder 330. The display device may then include the decoder function or the encoded stream may at a later stage be re-supplied to the rendering device for further decoding. A user interface 360 of the rendering apparatus enables the apparatus to interact with the user. The user interface 360 may include any suitable user input means, such as an Infrared receiver for receiving signals from an IR remote control, a keyboard, or a microphone for voice control. For output, also any suitable form may be used, such as using a small LCD display or using the display of a television, or even audible feedback. The rendering apparatus 300 also includes a memory 320. The memory may store the program executed by the processor 310. It may also contain data (such as settings for the various hardware/software functions of the apparatus), local content (such as audio/video/images), and bookmarks, as will be described in more detail below. Preferably, at least part of the memory is non-volatile (e.g. hard-disc, rewriteable optical storage, Flash) to store information that should be kept after a power-down.

Bookmarks

According to the invention, the system is able to generate bookmarks. Each bookmark identifies a respective server content item. To this end, the bookmark includes a server content locator. For example, the bookmark includes a URL to content on a web site. The bookmark may equally well include a URN (as described in more detail above) or a URI—Uniform Resource Identifier or other suitable identifiers for locating content in a server accessible through a network. The bookmark for the server content should be seen having a broader meaning than conventionally used in web browsers where the bookmark is limited to a URL. The server content locator may be, but is not limited to:
A bookmark of a specific page on a web site as is known from current web browsers, where the format of the page is not restricted to HTML but may in principle also be of a different format;
A bookmark of specific media content, that may be wrapped in an XML document, such as SMIL;
A bookmark of a location within streaming media, e.g. using a time indicator;
A bookmark of a position within an interactive chat application (e.g. to a web site that includes a chat or directors commentary that controls playback of the local content)

The server content item indicated in a bookmark is only rendered by the rendering apparatus if the rendering apparatus has access to the local content title to which the server content item relates. To this end, the bookmark also includes a local content identifier associated with the local content title. As described above, suitable candidates for use as a local content identifier are a TitleID, PublisherID, PublisherGroupId, DiscID, DiscFamilyID or a hash of the content. Also combination of such identifiers may be used. The local content identifier may be unique for the content (e.g. using the titleID or hash over selected content parts) or the instance of the content (e.g. using the titleID and DiscID). The local content identifier need not be unique, for example using a DiscFamilyId or PublisherID). Rules may be supplied to the creator of the bookmark on whether or not the local content identifier should be unique and if so on which identifier(s) it should be based. Preferably, such rules are stored on the web site involved. If the bookmark is created by the rendering apparatus, this apparatus can read and verify the rules and, if the rules are met, create a bookmark that complies with the rules. In particular, if the involved local content title is stored on a removable storage medium that includes a medium identifier (e.g. the DiscID for DVD) then it is preferred that the local content identifier includes the medium identifier to make the bookmark unique and as a simple test of authenticity.

In a preferred embodiment, the bookmarks are stored in the rendering apparatus, for example in memory 320. If so desired, the bookmarks may also be stored in other devices, e.g. in storage 230 of the local multi-media server 210 or in storage of a web-based server, such as server 110.

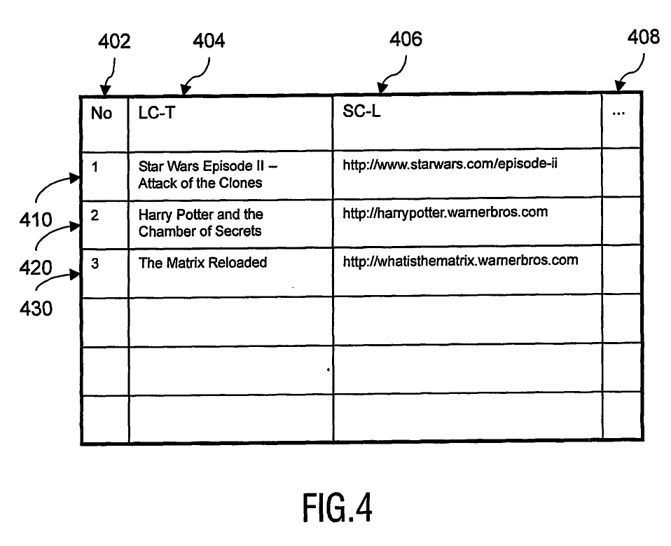

FIG. 4 shows an example of a structure for storing the bookmarks. In this example, the bookmarks are stored in the form of a table. For each bookmark the table includes a corresponding row. In the example of FIG. 4 three rows 410, 420, and 430 are filled with data. Each row (i.e. bookmark) includes several fields (columns). Shown are the field 404 for containing the local content title and the field 406 for the server content locator. Also shown is a field 402 that includes a bookmark identifier, such as a sequential number. This field is optional. In the example of FIG. 4, the local content title contains user-readable data. For presentation of the bookmarks it is preferred to store such a readable presentation. For the purpose of providing access to the server content conditional on the local content title being accessible, it is sufficient that the local content title is stored in a computer readable representation. This may also include a digital signature in a hexadecimal form. If so desired both a computer readable and human readable representation may be stored. In the example of FIG. 4, the server content locators are URLs that point to a ‘homepage’ that corresponds to the involved title. In practical use, the URL will point to more specific content on the web site (i.e. sub-pages). In addition to a URL or as an alternative to a URL, a URN can be stored e.g. “urn:isbn:088663475046569”. If the URL is not stored, a naming service can be used to convert the URN to a URL. More in general, the field 406 may include a URI—Uniform Resource Identifier. The identifier (URL, URN, URN, . . . ) may be not very readable and possibly long. Therefore, preferably also a name column with a readable form may be added to ease the user's navigation.

In a preferred embodiment, the user interface 360 of the rendering apparatus presents to a user which stored bookmarks are selectable for rendering of server content indicated by the respective bookmark. For example, the user interface may present only the selectable bookmarks (and not the non-selectable ones), highlight the selectable ones, or gray the non-selectable ones. A bookmark may be considered selectable if the rendering apparatus has access to a local content title associated with the local content identifier of the bookmark. If a user tries to select a non-selectable bookmark, the user may be prompted to make the involved local content accessible (e.g. insert the involved DVD). As described above, the association between the server and local content may, but need not be a one-to-one relationship. If rules are used, as described above, at the moment of presenting the bookmarks, the rendering apparatus may verify if the bookmark still complies with the then valid rules, as for example stored in the server indicated by the bookmark. Only bookmarks that still comply with the rules are presented as selectable.

Advantageously, the user interface presents the bookmarks to a user organized according to the local content identifiers of the bookmarks. For example, the bookmarks may be sorted on the titles of the local content. This enables a user to quickly locate the bookmarks that relate to a specific title (e.g. the main title on the currently inserted DVD). Preferably, upon making local content accessible to the rendering apparatus, the bookmarks that are related to that content are automatically shown. So, upon inserting a “Lord of the Rings” DVD all bookmarks to that web content linked to that DVD (or the family of DVDs) are shown.

In a preferred embodiment, the rendering apparatus is able to render a server content item indicated by the server content locator of a bookmark synchronous to rendering the local content title associated with the local content identifier of the bookmark. In response to a user selecting a bookmark, the rendering apparatus accesses both the involved local content and remote content. Preferably, additional data is retrieved by the rendering apparatus to enable accurate synchronization of the two content sources (which both may be streamed). Such data may be retrieved from the web page involved. The bookmark may also include an additional field specifying allocation of synchronization data In the case where content blocks of both sources is streamed, the synchronization data may, for example, couple time indicators of both streams.

In addition to storing the local content identifier in the bookmark, separately accessible items of the local content may be identified by respective local content locators.

This additional detail is then also stored in a field of the bookmark. The local content locator may take any suitable form, such as a time indicator (“play back time”). Use of such a detailed indication enables starting of the rendering of the local content title at a location indicated by the local content locator instead of at the beginning of the title.

In a preferred embodiment, the bookmark includes a user ID identifying a user of the rendering apparatus, and/or a family ID identifying a family of users of the rendering apparatus. The family ID may, for example, be used for any bookmark relevant for the entire family, whereas a specific user ID is used for bookmarks of main interest to the involved user. A user ID may be stored as a digital number in the bookmark table. Preferably, additionally or alternatively a readable word is used, such as the name of the user. The family ID can simply be a specific, possibly reserved, user ID. For example, it could be the first sequence number of the user IDs or it could be a name such as “family” or “all”. The user interface can organize the stored bookmarks according to the user ID and/or family ID of the bookmarks. For example, it can sort the bookmark list on the user ID or only present bookmarks that match a setting in the rendering apparatus representing the current viewer/listener. Such a user ID setting of the rendering apparatus may be obtained by the rendering apparatus in any suitable way (e.g. by letting a user specify its ID, or in some way estimating/recognizing the user ID, possibly based on voice recognition).

To enhance the system further, the bookmark may include a parental level indicator. The rendering apparatus can use this additional information to decide whether or not to present a bookmark and/or to render a remote item indicated by a bookmark. It may choose to do such an operation on the condition that a parental level setting of the rendering apparatus allows it, i.e. the parental level setting of the rendering apparatus ‘matches’ the parental level indicator of the bookmark. Any suitable type of parental levels may be used. For example, if a parental level setting in the bookmark is U—Unrestricted, access may always be granted. If the parental level setting in the bookmark is PG—Parental Guidance, then the setting of the rendering apparatus should indicate that the rendering apparatus may be used for rendering unrestricted and PG content. Similarly, if the parental level setting in the bookmark is Adults Only, then the setting of the rendering apparatus should indicate that the rendering apparatus may be used for rendering Adults Only content (and implicitly also all other content).

In many cases, the trigger for generating and storing a bookmark is an action from the user. For example, an explicit instruction from a user received via the user interface. A remote control may be equipped with a separate button (either a mechanical button or a logical button selectable on a display) for a ‘one-click’ generation and storing of a bookmark. The generated bookmarks includes then at least the server content locator identifying a server content item currently being rendered and a local content identifier associated with a local content item that currently is accessible. In particular, the local content identifier can be derived from a suitable identifier of a disc with the local content in a local drive. If the local content is currently also being played, the local content identifier may include a detailed local content locator, as described above. Optionally, at the moment of creation settings of the rendering apparatus may be copied into the bookmark, such as the user ID of the user currently using the apparatus. Also settings associated with the remote content may be copied from the server, such as parental level required for accessing the remote content. The rendering apparatus may by default give a newly created bookmark that points to a part of remote content with unrestricted access a user ID value that corresponds to the family ID. A bookmark that points to a part with restricted access (e.g. with adult material) is preferably by default assigned to the user ID of the current user. The user may locate server content that relates to a local title in any suitable way. For example, the user may browse through the Internet in a known way or may search the Internet. In particular, the local content may include links to possibly interesting sites. Also a separate server may provide linking information for specific local content titles. The reverse way is also possible: a sever in the Internet may indicate for which local titles it contains additional content.

Additionally or alternatively, the system is operative to generate bookmarks automatically. For example, a bookmark is created for a server content item in response to an instruction to terminate rendering of a server content item. This enables resumption of rendering of the server content item. Such a ‘termination’ bookmark may be handled separately by the system. It need not be displayed to a user and may be used to ‘automatically’ resume playback at a next session (e.g. when a disc with the local content is again inserted in the drive). If so desired the ‘automatic’ resumption only takes place upon an approval of a user or upon an explicit ‘resumption’ instruction of the user, e.g. by pressing a resume button on the remote control. A bookmark may also be created automatically each time a user selects a new server content item for rendering. In this way a history list of bookmarks is created. To restrict memory requirements for storing bookmarks, the number of bookmarks on such a history list may be limited to, e.g. ten bookmarks. The history list may be assigned to the current user, giving a personal history list. In the user interface, preferably the history list is kept separate from the bookmarks created on the initiative of the user.

As described above, the access to the server content is conditional on certain local content being accessible. In particular, only if local content is present which the user is entitled to use (e.g. has paid for) is the additional server content accessible. Nowadays, much local content can be copied easily. In a preferred embodiment, the rendering apparatus is able to verify an authenticity of an accessible local content title. Increasingly, content is distributed in a way that the authenticity can be verified. The rendering apparatus can use these mechanisms. Such mechanisms are well-known for distribution of content on a removable storage medium (e.g. DVD) or via broadcasting or direct electronic transfer (e.g. using conditional access methods). Only if the authenticity is verified, will the rendering apparatus render a server content item indicated by the server content locator of a bookmark.

Preferably, the bookmarks are created and stored in (or in a storage directly accessible by) the rendering apparatus. However, also a server in the network may provide such a service. This could be a general server that provides the service in principle for all local titles and all content in servers in the network (possibly against payment for this service). It is also possible that a server only provides the service for local content for which it supplies additional content. For example, a Harry Potter web server provides the service only if a Harry Potter DVD is inserted in the rendering apparatus.

If local content is made accessible to the rendering apparatus (e.g. a disc is inserted), the local content identifier may be determined by the rendering apparatus. It can then check the file with the bookmarks to see if bookmarks are available for the content. If so, it may automatically present the bookmarks or show a “bookmark” button on a display that the user may activate. Activation of the button can trigger the display of relevant bookmarks. Similarly, a history list of bookmarks may be presented directly or through a button upon insertion of the disc to which the history list relates (for example, the history list may be filtered with the DiscID of the currently inserted disc).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (100) including a rendering apparatus (120), a server (110) and a network (130) for communication between the rendering apparatus and the server;
the server having access to content, hereinafter referred to as “server content”; separately accessible items of the server content being identified by respective server content locators, such as a URL;
the rendering apparatus having access to further content, hereinafter referred to as “local content”; titles of the local content being associated with respective local content identifiers; the rendering apparatus being operative to render items of the local content and to render server content items that relate to the local content items;
the system being operative to generate and to store a plurality of bookmarks identifying respective server content items; each bookmark including a server content locator and a local content identifier; and
the rendering apparatus being operative to render a server content item indicated by the server content locator of a bookmark conditional on having access to a local content title associated with the local content identifier of the bookmark.

2. A system as claimed in claim 1, wherein the rendering apparatus includes a user interface for presenting to a user which stored bookmarks are selectable for rendering of server content indicated by the respective bookmark.

3. A system as claimed in claim 1, wherein a bookmark is selectable only if the rendering apparatus has access to a local content title associated with the local content identifier of the bookmark.

4. A system as claimed in claim 1, wherein the rendering apparatus includes a user interface for presenting bookmarks to a user organized according to the respective local content identifiers of the bookmarks.

5. A system as claimed in claim 1, wherein the rendering apparatus is operative to render a server content item indicated by the server content locator of a bookmark synchronous to rendering the local content title associated with the local content identifier of the bookmark.

6. A system as claimed in claim 5, wherein separately accessible items of the local content are identified by respective local content locators, such as a time indicator; the bookmark including a local content locator enabling starting the rendering of the local content title at a location indicated by the local content locator.

7. A system as claimed in claim 1, wherein the bookmark includes a user ID identifying a user of the rendering apparatus, and/or a family ID identifying a family of users of the rendering apparatus.

8. A system as claimed in claim 7, wherein the user interface is operative to present the stored bookmarks organized according to the user ID and/or family ID of the bookmarks.

9. A system as claimed in claim 1, wherein the bookmark includes a parental level indicator; the rendering apparatus being operative to present a bookmark and/or to render a remote item indicated by a bookmark only if the parental level indicator of the bookmark matches a parental level setting of the rendering apparatus.

10. A system as claimed in claim 1, wherein the system is operative to generate and store a bookmark in response to an instruction from a user, where the generated bookmarks includes a server content locator identifying a server content item currently being rendered and a local content identifier associated with a local content item that currently is accessible.

11. A system as claimed in claim 1, wherein the system is operative to generate bookmarks automatically.

12. A system as claimed in claim 11, wherein the system is operative to generate a bookmark for a server content item in response to an instruction to terminate rendering of a server content item to enable resumption of rendering of the server content item.

13. A system as claimed in claim 11, wherein the system is operative to generate a bookmark for a server content item in response to a user selecting a server content item for rendering, creating a history list of bookmarks.

14. A system as claimed in claim 1, wherein the rendering apparatus is operative to verify an authenticity of an accessible local content title and to render a server content item indicated by the server content locator of a bookmark only upon a positive outcome of the verification.

15. A system as claimed in claim 1, wherein a local content title is stored on a removable storage medium including a medium identifier; the local content identifier including the medium identifier.

16. A rendering apparatus for use in the system as claimed in claim 1; the rendering apparatus being operative to generate the bookmarks.

17. A server for use in the system as claimed in claim 1; the server being operative to store the bookmarks.

18. A method of generating a bookmark to content in a server accessible through a network; the method including:
retrieving a local content identifier associated with a title of content accessible for rendering by a rendering apparatus local to the content;
retrieving a server content locator, such as a URL, identifying a separately accessible item of the server content that is related to the local content title; and
generating and storing a bookmark that includes the server content locator and the local content identifier.

19. A method of accessing content in a server accessible through a network; the method including:
retrieving a bookmark that includes:
a local content identifier associated with a title of content accessible for rendering by a rendering apparatus local to the content; and
a server content locator, such as a URL, identifying a separately accessible item of the server content that is related to the local content title; and
rendering a server content item indicated by the server content locator of the bookmark conditional on having access to the local content title associated with the local content identifier of the bookmark.

20. A computer program product operative to cause a processor to perform the method of claim 18.
